(19) United States
(12) Patent Application Publication
(10) Pub. No.: US 2003/0063067 A1
(43) Pub. Date: Apr. 3, 2003

(54) Real-time handwritten communication system

(76) Inventor: Ping-Yang Chuang, Taipei (TW)

Correspondence Address: BIRCH STEWART KOLASCH & BIRCH, PO BOX 747, FALLS CHURCH, VA, 22040-0747, US

(21) Appl. No.: 10/261,588

(22) Filed: Oct. 2, 2002

(30) Foreign Application Priority Data
Oct. 2, 2001 (TW) 090124321

(51) Int. Cl. G09G 5/00

(52) U.S. Cl. 345/156

(57) ABSTRACT

A real-time handwritten communication system comprises a touch panel, a touch pen, a data input device, a controller device, a data output device and a display device. The touch panel for inputting handwritten data by the touch pen can convert the handwritten data into output data. The data input device receives input data transmitted from another real-time handwritten communication system and inputs the input data to the real-time handwritten communication system, and a data format of the input data is dependent on the data input device. The controller device connects with the touch panel and the data input device, and treats and transmits the input data and the output data in real-time. The data output device connects to the controller device and transmits the output data from the touch panel of the real-time handwritten communication system to another real-time handwritten communication system. The display device connects to the controller device to display the input data and the output data. Users communicate in real-time with each other by handwriting input with their own real-time handwritten communication system.

This application incorporates by reference of Taiwan application Serial No. 090124321, filed Oct. 2, 2001.

### BACKGROUND OF THE INVENTION

1. Field of the Invention

The invention relates in general to a data input/output apparatus, and more particularly to a real-time handwritten communication system.

2. Description of the Related Art

With the development of industry and commerce and the alteration of lifestyle, people interact with each other more and more frequently. Even science and technology change with each passing day, spoken expressions are still the most convenient and direct interconnection. The objective of from traditional corded phone to advanced wireless communication apparatus is to make people orally communicate with each other in real-time without limiting by distance, topography and so on and to bring more convenient life for people.

However, for people hard of hearing, mute or hard of speaking, due to their own ability, they cannot enjoy the convenience of the high-tech products. When they communicate with people far away or face-to-face, all they can use are communicating with pen and paper, for example writing traditional mail to contact with people far away. They also can use e-mail to communicate with persons far away but it is impossible for them to communicate with each other in real-time.

For normal persons they can speak without blocking, however, it is necessary to express with other modes, such as writing, picturing and so on, sometimes so as to completely convey their concepts and thoughts. In such situation, the advanced wireless communication apparatus have its limitation of functions and does not have those communicating functions to assist people in expressions.

### SUMMARY OF THE INVENTION

It is therefore an object of the invention to provide a real-time handwritten communication system so that users can communicate with handwriting in real-time with each other.

The invention achieves the above-identified object by providing a real-time handwritten communication system comprising a touch panel, a touch pen, a data input device, a controller device, a data output device and a display device. The touch panel for inputting handwritten data by the touch pen can convert the handwritten data into output data. The data input device receives input data transmitted from another real-time handwritten communication system and inputs the input data to the real-time handwritten communication system, and a data format of the input data is dependent on the data input device. The controller device connects with the touch panel and the data input device, and treats and transmits the input data and the output data in real-time. The data output device connects to the controller device and transmits the output data from the touch panel of the real-time handwritten communication system to another real-time handwritten communication system. The display device connects to the controller device to display the input data and the output data. Users communicate in real-time with each other by handwriting input with their own real-time handwritten communication system.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 shows a circuit block diagram of a real-time handwritten communication system according to the present invention.

FIG. 2 shows a real-time handwritten communication system according to the first embodiment of the present invention.

FIG. 3 shows a real-time handwritten communication system according to the second embodiment of the present invention.

FIG. 4 shows a real-time handwritten communication system according to the third embodiment of the present invention.

FIG. 5 shows a real-time handwritten communication system according to the forth embodiment of the present invention.

### DETAILED DESCRIPTION OF THE INVENTION

The spirit of the present invention is to provide a real-time handwritten communication system cooperating with existing electronic communication apparatuses and communication networks so that users can communicate with each other in real-time by handwriting.

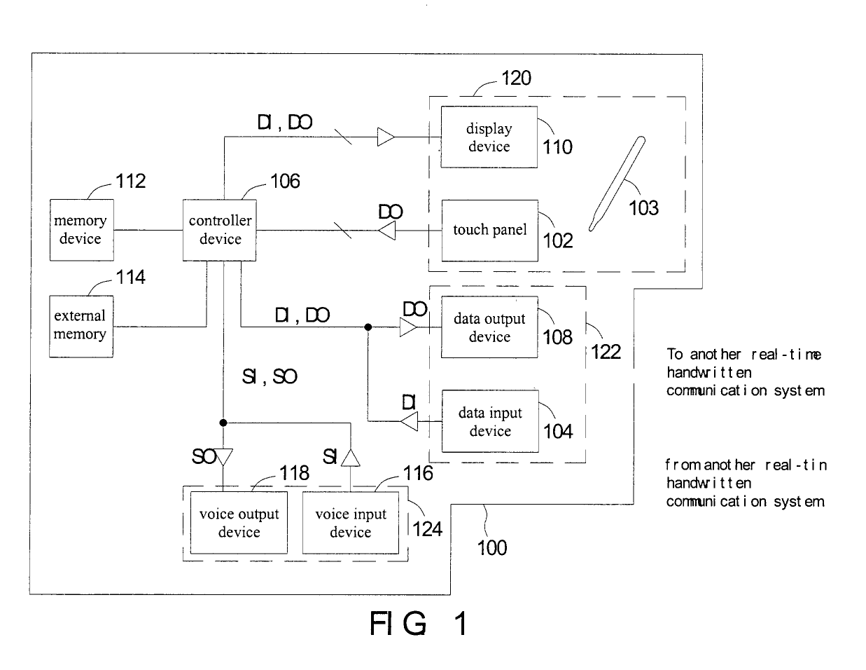

Referring to FIG. 1, it shows a circuit block diagram of a real-time handwritten communication system 100 according to the present invention. Persons hard of hearing, mute or hard of speaking or anyone unable to express thoughts with spoken language can communicate with others by the real-time handwritten communication system 100. The real-time handwritten communication system 100 comprises a touch panel 102, a touch pen 103, a data input device 104, a controller device 106, a data output device 108 and a display device 110, and the connections of those elements are shown in FIG. 1 without tautology.

When a user wants to transmit messages to another, the user can write words or symbols or draw pictures on the touch panel 102 with the touch pen 103. The words, symbols or pictures on the touch panel 102 can be recognized and are output as outputting data DO. The controller device 106 connecting with the touch panel 102 is a central processing unit (CPU) and connects with the data output device 108. When the outputting data DO are input to the controller device 106 from the touch panel 102, the outputting data DO are converted by the controller device 106 to a data format recognized by the data output device 108. The outputting data DO are then output from the data output device 108 to another user's real-time handwritten communication system or other users' real-time handwritten communication systems.

The real-time handwritten communication system 100 can use several kinds of communication apparatuses, such as mobile phone, corded phone, pager, wireless transceiver, or other electronic communication terminal apparatuses, as the data output device 108 and the data input device 104. The electronic communication terminal apparatus is also called data input/output device 122. When the real-time handwritten communication system 100 uses the existing communication apparatus as the data input/output device 122, data can be promptly transmitted with the wire or wireless communication networks used in the communication apparatus to communicate with another user or other users who may be far away in real-time.

The outputting data DO are output from the real-time handwritten communication system 100 by the existing electronic communication terminal apparatus and the wire or wireless communication networks used in the electronic communication terminal apparatus, and transmitted to another user who also uses his own real-time handwritten communication system. When the outputting data DO are received by another user's data input device, they become inputting data of another user's real-time handwritten communication system. Similarly, another user's outputting data output from his real-time handwritten communication system to the user's real-time handwritten communication system 100 become the user's inputting data DI and received by the data input device 104. After the inputting data DI input to the real-time handwritten communication system 100, the inputting data DI are transmitted to the controller device 106. The data format of the inputting data DI depends on the used electronic communication apparatus and the used communication network. The inputting data DI are treated by the controller device 106 and converted to the data format recognized by the display device 110. The display device 110 connects to the controller device 106 and is liquid crystal display (LCD) which can display the inputting data DI and the outputting data DO. For example, when two users are communicating with each other with their own real-time handwritten communication system, the outputting data DO which is written on the touch panel 102 by the user and the inputting data DI from another user can display on the display device 110 at the same time.

The touch panel 102 and the display device 110 can be combined into a touch display panel 120. When the user uses the touch pen 103 to write on the touch display panel 120, the written data are displayed at the location where the touch pen pressed in real-time. The real-time handwritten communication system 100 also can be integrated in a personal digital assistance (PDA) apparatus and using the existing communication apparatus as the data input/output device 122, therefore, the user can use the personal digital assistance apparatus communicate with another user or other users in real-time.

The real-time handwritten communication system 100 further comprises a memory for storing a dialogue record including the inputting data DI and the outputting data DO. The memory disposing in the real-time handwritten communication system 100 can also pre-store some complicated figures, such as maps, and image information, such as photographs or pictures, to assist users in real-time communication. During communicating, the figures and image information can be got from the memory by the controller device 106 and displayed on the touch display panel 120. The pre-stored complicated figures and image information can make the communication more convenient. For example, if the user arranges the meeting place, the corresponding map stored in the memory can be got and displayed on the touch display panel 120 and clearly marking the meeting place on the displayed map. The memory can be a built-in memory device 112, such as read only memory (ROM) or random access memory (RAM), or an external memory.

The real-time handwritten communication system 100 further comprises a voice data output device 118 and a voice data input device 116, which connect to the controller device 106. Therefore, users can communicate with not only written data but also voice data. Moreover, music can be stored in the memory by the voice data input device 116 and output anytime by the voice data output device 118, which are functioned as Walkman.

The real-time handwritten communication system 100 can use several kinds of communication apparatuses, such as mobile phone, corded phone or other electronic communication terminal apparatuses, as the voice data output device 118 and the voice data input device 116. The electronic communication terminal apparatus is also called voice input/output device 124.

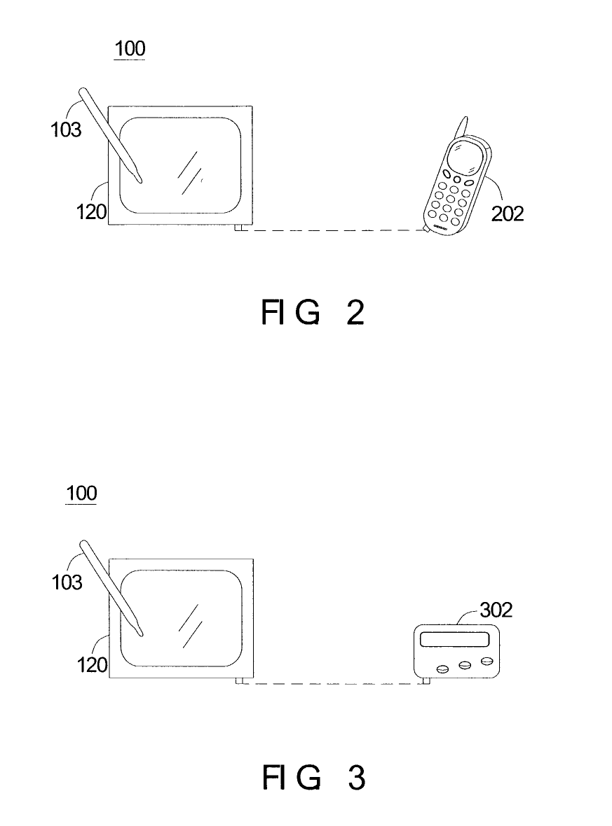

Referring to FIG. 2, it shows a real-time handwritten communication system 100 according to the first embodiment of the present invention. In the first embodiment, a mobile phone 202 is used as the data input/output device 122 in the real-time handwritten communication system 100 and the wireless communication network used in the mobile phone 202 is used to transmit data. The connection between the controller device 106 (not shown in FIG. 2) and the mobile phone 202 is wireless, such as infrared ray transmission or optical transmission. Because GPRS (general packet radio service) system and CDMA (code-division multiple access) system have the characteristic of frequency division, the digital data and the voice data can be transmitted individually. If the real-time handwritten communication system 100 uses the mobile phone 202 with GPRS system to transmit data, the user can handwrite data or speak to communicate with another user. In such case, the mobile phone 202 is not only the data input/output device 122 but also the voice input/output device 124 of the real-time handwritten communication system 100.

Referring to FIG. 3, it shows another real-time handwritten communication system 100 according to the second embodiment of the present invention. In the second embodiment, a pager 302 is used as the data input/output device 122 in the real-time handwritten communication system 100. Due to the limiting functions, the user can only communicate by handwritten. Furthermore, a wireless transceiver can also be the data input/output device 122 of the real-time handwritten communication system 100.

Referring to FIG. 4, it shows another real-time handwritten communication system 100 according to the third embodiment of the present invention. Not only wireless communication network but also wire communication network can be used in the real-time handwritten communication system 100 to transmit data. As shown in FIG. 4, a corded phone 402 is used as the data input/output device 122 of the real-time handwritten communication system 100 and connects to the real-time handwritten communication system 100 via a connector 404 and phone line 406. Therefore, the real-time handwritten communication system 100 can use modem used for the corded phone 402 to transmit the inputting data DI and the outputting data DO.

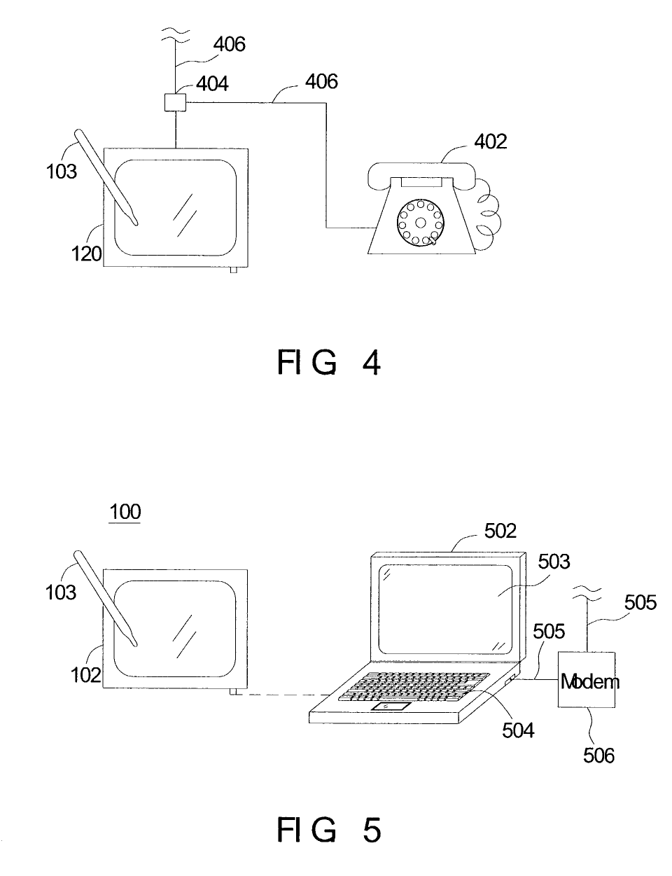

Referring to FIG. 5, it shows another real-time handwritten communication system 100 according to the forth embodiment of the present invention. The real-time handwritten communication system 100 can connect with computer 502, and using the monitor 503 of the computer 502 as the display device 110 and the keyboard 504 of the computer 502 as the handwriting assistant tool. The computer 502 connects with modem 506 with wire or wireless so as to connect to internet. Therefore, the real-time handwritten communication system 100 can transmit through the internet to communicate with another user.

It should be noted that not only wire or wireless communication network can be used to transmit data peer-to-peer in the real-time handwritten communication system 100, but also server can be used to connect with several real-time handwritten communication systems. Therefore, more than two users can communicate with their own real-time handwritten communication systems.

The real-time handwritten communication system of the present invention can be integrated with the existing electronic communication apparatuses and communication networks, therefore, users can communicate by handwriting with other users far away in real-time. Persons who are hard of hearing, mute or hard of speaking or anyone unable to express completely thoughts with spoken language can communicate with others by the real-time handwritten communication system.

Furthermore, the real-time handwritten communication system can be equipped with the existing electronic communication apparatuses to communicate with others by handwriting and speaking in real-time.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A real-time handwritten communication system, comprising:
a touch pen;
a touch panel for inputting handwritten data by the touch pen and for converting the handwritten data into output data, wherein the output data are displayed on a display device;
a data input device for receiving input data transmitted from another real-time handwritten communication system and inputting to the real-time handwritten communication system, wherein a data format of the input data is dependent on the data input device, wherein the input data are displayed on the display device;
a controller device connecting with the touch panel and the data input device, and treating and transmitting the input data and the output data in real-time;
a data output device connecting to the controller device and transmitting the output data from the touch panel of the real-time handwritten communication system to another real-time handwritten communication system; and
the display device connecting to the controller device to display the input data and the output data,
wherein users communicate in real-time with each other by handwriting input with their own real-time handwritten communication system.

2. The real-time handwritten communication system according to claim 1, wherein the data output device connects with other real-time handwritten communication systems' data input devices by a communication network.

3. The real-time handwritten communication system according to claim 2, wherein the communication network is wire communication network.

4. The real-time handwritten communication system according to claim 2, wherein the communication network is wireless communication network.

5. The real-time handwritten communication system according to claim 1, wherein when a first user using a first real-time handwritten communication system and a second user using a second real-time handwritten communication system communicate at real-time with each other, the output data from the first real-time handwritten communication system are corresponding input data of the second real-time handwritten communication system, and the input data received by the first real-time handwritten communication system are corresponding output data of the second real-time handwritten communication system.

6. The real-time handwritten communication system according to claim 1, wherein the output data are treated by the controller device to match a data format identified by the output data device, the input data are treated by the controller device to match a data format identified by the display device.

7. The real-time handwritten communication system according to claim 1, wherein the touch panel and the display device are combined into a touch display panel, and a location of the input data on the touch display panel is corresponding to a handwriting location of the touch pen.

8. The real-time handwritten communication system according to claim 1, wherein the display device is liquid crystal display (LCD) panel.

9. The real-time handwritten communication system according to claim 1, wherein the touch pen, the touch panel, the controller device and the display device are integrated in a personal digital assistance (PDA) apparatus.

10. The real-time handwritten communication system according to claim 1, wherein the data output device and the data input device connect to the controller device with wireless.

11. The real-time handwritten communication system according to claim 10, wherein the data output device and the data input device are a mobile phone.

12. The real-time handwritten communication system according to claim 11, wherein the mobile phone uses GPRS (general packet radio service) system.

13. The real-time handwritten communication system according to claim 11, wherein the mobile phone uses CDMA (code-division multiple access) system.

14. The real-time handwritten communication system according to claim 10, wherein the data output device and the data input device are a pager.

15. The real-time handwritten communication system according to claim 10, wherein the data output device and the data input device are a wireless transceiver.

16. The real-time handwritten communication system according to claim 10, wherein the data output device and the data input device are a computer.

17. The real-time handwritten communication system according to claim 1, wherein the data output device and the data input device connect to the controller device with wire.

18. The real-time handwritten communication system according to claim 17, wherein the data output device and the data input device are a corded phone.

19. The real-time handwritten communication system according to claim 1, wherein the controller device is central processing unit (CPU).

20. The real-time handwritten communication system according to claim 1, further comprising a memory for storing a dialogue record including the input data and the output data and connecting to the controller device.

21. The real-time handwritten communication system according to claim 1, further comprising a memory for storing image information displayed on the display device to assist real-time communication.

22. The real-time handwritten communication system according to claim 20 and 21, wherein the memory is external memory.

23. The real-time handwritten communication system according to claim 20 and 21, wherein the memory is read only memory (ROM).

24. The real-time handwritten communication system according to claim 20 and 21, wherein the memory is random access memory (RAM).

25. The real-time handwritten communication system according to claim 1, further comprising a voice data output device for outputting voice output data and a voice data input device for receiving voice input data, wherein the voice data output device and the voice data input device connect to the controller device so that the real-time handwritten communication system has functions of sound recording and playing.

26. The real-time handwritten communication system according to claim 25, wherein the voice data output device is earphones.

27. The real-time handwritten communication system according to claim 25, wherein the voice data output device is trumpet.

28. The real-time handwritten communication system according to claim 25, wherein the voice data output device is microphone.

29. The real-time handwritten communication system according to claim 1, wherein the user can communicate with another user or other users by their own voice real-time handwritten communication system.
